(19) United States
(12) Patent Application Publication
(10) Pub. No.: US 2026/0266992 A1
(43) Pub. Date: Sep. 10, 2026

(54) OPTICAL SENSOR

(71) Applicant: OMRON Corporation, Kyoto-shi, Kyoto (JP)

(72) Inventors: Katsushi Takaichi, Kyoto-shi, Kyoto (JP); Jumpei Nakamura, Kyoto-shi, Kyoto (JP); Ryosuke Tsuzuki, Kyoto-shi, Kyoto (JP)

(21) Appl. No.: 19/162,337

(22) PCT Filed: Feb. 27, 2024
(86) PCT No.: PCT/JP2024/006960

§ 371 Date: Sep. 4, 2025

(30) Foreign Application Priority Data
Mar. 15, 2023 (JP) 2023-040357
Sep. 1, 2023 (JP) 2023-142174

(51) Int. Cl. G01S 17/08

(52) U.S. Cl. CPC G01S 17/08

(57) ABSTRACT

To provide an optical sensor capable of reducing a difference in a light intensity between a central portion and a peripheral portion of a spot. The optical sensor (1) is a distance-setting type optical sensor including a light source (5) configured to emit a Gaussian beam (A) and at least one distribution change element (10). Each of the at least one distribution change element (10) is configured to change the Gaussian beam (A) emitted from the light source (5) to a beam (B) having a light intensity distribution other than a Gaussian type.

This is a U.S. national stage application under 35 U.S.C. § 371 of International Application No. PCT/JP2024/006960, filed on Feb. 27, 2024, which claims the benefit of and priority to Japanese Patent Application No. 2023-040357, filed on Mar. 15, 2023, and Japanese Patent Application No. 2023-142174, filed on Sep. 1, 2023, the entire contents of each of which are incorporated herein by reference.

### TECHNICAL FIELD

The present disclosure relates to an optical sensor.

### BACKGROUND

There is an optical sensor that detects a missing workpiece or the like using reflection of light. When the workpiece has a recessed portion or a through hole, the reflectance of light locally changes. For example, when the workpieces are bottles arranged on a pallet, a deep valley is formed in a gap between adjacent bottles. When the size of the spot to which the laser is applied is enlarged to be larger than the recessed portion of the workpiece, even such a workpiece can be stably detected. Patent Document JP 2015-78946 A discloses a technique capable of changing the size of a spot by disposing a flat plate for changing an optical path length between a laser diode and a light projecting collimator.

### BRIEF SUMMARY

Light emitted from a light source such as a laser diode has a Gaussian type light intensity distribution in which a central portion of a spot is bright and a peripheral portion thereof is dark. A Gaussian beam is maintained by simply widening the spot as in the technique described in JP 2015-78946 A. When the size of the spot is widened, the spot becomes dark as a whole, and therefore, in the peripheral portion which is darker than the central portion, when the size of the spot is widened, the light intensity required for detecting the workpiece may not be obtained. When the light intensity is insufficient, the presence or absence of the workpiece may not be accurately detected.

The present disclosure has been made in view of such a problem, and provides an optical sensor capable of reducing a difference in a light intensity between a central portion and a peripheral portion of a spot.

Further, as in the technique described in JP 2015-78946 A, when a plurality of flat plates are arranged in a circumferential shape on the conversion element holder which is a rotating disk, the optical axis of the beam and the rotation axis of the conversion element holder become parallel to each other. Since the trimmer operation unit for rotating the conversion element holder is disposed on the back surface of the main body case, it is difficult to visually check the optical axis while operating the trimmer operation unit. The light emitting element as a light source is disposed in a space between the back surface of the main body case and the conversion element holder. When the conversion element holder is a rotating disk, the shaft of the trimmer operating portion extending from the back surface of the main body case to the conversion element holder becomes long due to the space occupied by the light emitting element. The longer the shaft, the thicker the shaft to withstand the torque required to drive the conversion element holder. It is difficult to miniaturize an optical sensor.

Further, as in the technique described in JP 2001-264453 A, the shape of the spot can be changed by moving the light projecting lens closer to or away from the light source. However, in the technique described in JP 2001-264453 A, the variable range of the spot depends on the displacement amount of the light projecting lens in the optical axis direction. If an attempt is made to increase the variable range to the same extent as in the technique described in JP 2015-78946 A, the space occupied by the mechanism for displacing the light projecting lens increases, and thus it is more difficult to reduce the size of the optical sensor than in the technique described in JP 2015-78946 A.

The present disclosure has been made in view of the above problems, and provides an optical sensor which is compact and excellent in operability.

An optical sensor according to an aspect of the present disclosure is an optical sensor of a distance-setting type, the optical sensor including a light source configured to emit a Gaussian beam and at least one distribution change element, wherein each of the at least one distribution change element is configured to change the Gaussian beam emitted from the light source to a beam having a light intensity distribution other than a Gaussian type.

According to this aspect, since it is possible to change from a beam having a Gaussian type light intensity distribution (Gaussian beam) in which the central portion of the spot is bright and the peripheral portion is dark to a beam having a light intensity distribution other than the Gaussian type, it is possible to reduce the difference in a light intensity between the central portion and the peripheral portion of the spot.

In the above aspect, the at least one distribution change element is a plurality of distribution change elements including a first distribution change element and a second distribution change element, and the first distribution change element and the second distribution change element may be configured to be switched to switch a shape of a spot of the beam having the light intensity distribution other than the Gaussian type.

In the case of a workpiece without a recessed portion or a through hole, a smaller spot size is less likely to cause a malfunction due to disturbance and enables stable detection of the workpiece. On the other hand, in the case of a workpiece having a recessed portion or a through hole, the workpiece can be stably detected by increasing the spot size even when the reflectance of light changes at the recessed portion. There is a demand to enlarge, reduce, or change the size of the spot in accordance with the workpiece. According to this aspect, by switching between the first distribution change element and the second distribution change element, the size of the spot can be changed to be enlarged or reduced in accordance with the workpiece.

In the above aspect, each of the at least one distribution change element may be configured to change the Gaussian beam emitted from the light source into a beam having a top-hat light intensity distribution.

In the above aspect, each of the at least one distribution change element may be configured to change the Gaussian beam emitted from the light source to a beam having a light intensity distribution in which a light intensity of a peripheral portion of a spot is greater than a light intensity of a central portion of the spot.

When the size of the spot is widened, the spot becomes dark as a whole; therefore, in the Gaussian type light intensity distribution in which the central portion of the spot is bright and the peripheral portion is dark, in a case where the size of the spot is widened in the peripheral portion darker than the central portion, the light intensity required for detecting the workpiece may not be obtained. According to these aspects, it is easy to obtain the light intensity required for detecting the workpiece even at the peripheral portion of the spot, and it is possible to stably detect the presence or absence of the workpiece.

In the above aspect, a collimator configured to collimate the Gaussian beam emitted from the light source and cause the collimated Gaussian beam to enter the at least one distribution change element may be further provided.

According to this aspect, it is easy to calculate the intensity of the Gaussian beam incident on the distribution change element and the intensity of the beam emitted from the distribution change element, and therefore it is easy to design the distribution change element to have a desired spot shape.

In the above aspect, the optical sensor may be a time of flight (TOF) sensor configured to measure a distance based on a time taken for a beam projected at a constant period to be reflected by a workpiece and return.

When a distance-setting type optical sensor is used as an optical sensor for detecting a missing workpiece or the like, the presence or absence of a workpiece is detected by measuring the distance to the workpiece instead of the amount of received light, and thus the optical sensor is less likely to be affected by the color or shape of the workpiece. Examples of the distance-setting type optical sensor include a TOF sensor and a triangulation sensor. Among distance-setting type optical sensors, a triangulation sensor is compatible with a line beam spreading in the X-axis when the axis along which a light projecting unit and a light receiving unit are arranged is the Y-axis and the axis along which a Gaussian beam travels is the Z-axis, and can stably detect the presence or absence of a workpiece even if the size of the spot of the line beam spreads. Among the distance-setting type optical sensors, the TOF sensor is compatible with not only a line beam but also spots having various shapes including a circular shape, a rectangular shape, and the like, and can stably detect the presence or absence of a workpiece even when the size of the spot is widened. Since the shape of the spot is not limited, the TOF sensor is particularly preferable among the distance-setting type optical sensors. According to this aspect, since it is easy to obtain the light intensity required for detecting the workpiece even at the peripheral portion of the spot, it is particularly suitable for the TOF sensor.

In the above aspect, the distribution change element is a microlens array including a plurality of spherical lenses or a plurality of cylindrical lenses, and may be configured to change Gaussian beams, each emitted from the light source and passing through each of the plurality of spherical lenses or each of the plurality of cylindrical lenses, into a beam having a light intensity distribution other than the Gaussian type by overlapping the Gaussian beams with one another.

In the above aspect, the distribution change element is a diffractive optical element, and may be configured to diffuse the Gaussian beam emitted from the light source to change the Gaussian beam into a beam having a light intensity distribution other than the Gaussian type.

In the above aspect, the distribution change element is a multi-stage lens including at least one concave lens and at least one convex lens, and may be configured to change the Gaussian beam emitted from the light source to a beam having a light intensity distribution other than the Gaussian type by diverging the Gaussian beam with the at least one concave lens and converging the Gaussian beam with the at least one convex lens. At this time, a part or entire of the at least one convex lens may be constituted by a liquid lens.

According to these aspects, the distribution change element that changes the Gaussian beam emitted from the light source into a beam having a light intensity distribution other than the Gaussian type can be configured using an easily available and inexpensive member.

An optical sensor according to another aspect of the present disclosure includes a light source, and a spot variable mechanism configured to switch a shape of a spot of a beam by switching an optical element disposed on an optical path of the beam emitted from the light source. The spot variable mechanism includes a plurality of optical elements linearly arranged along a first direction intersecting a traveling direction of the beam, and a linear motion mechanism capable of linearly reciprocating the plurality of optical elements along the first direction.

According to this aspect, since the plurality of optical elements are not rotated by the rotation mechanism but are linearly moved by the linear motion mechanism, the optical axis and the rotation axis are not parallel to each other. To operate a trimmer while visually confirming an optical axis. In addition, it is easy to reduce the size of the optical sensor compared to the related art in which the light projecting lens is displaced or the rotating disk is rotated. Therefore, it is possible to provide a compact optical sensor having excellent operability.

In the above aspect, the linear motion mechanism may be a rack-and-pinion mechanism and may include a rack extending linearly along the first direction and a pinion meshing with the rack.

According to this aspect, the linear motion mechanism can be configured with a small number of components including only the rack and the pinion.

In the above aspect, a housing that houses the light source may be further included, and the pinion may be configured to be operable from a first surface of the housing facing a second direction intersecting both the traveling direction and the first direction.

In the above aspect, a housing that houses the light source and a display that can display information related to the setting of the optical sensor may be further included, and the pinion may be configured to be operable from a first surface of the housing on which the display is disposed.

According to these aspects, the pinion can be operated from the first surface side on which the optical axis can be visually confirmed, or the pinion can be operated from the first surface side on which the display can be visually confirmed, and thus workability is excellent.

In the above aspect, the plurality of optical elements include a first optical element and a second optical element, the spot variable mechanism further includes a convex portion, a first recessed portion that faces the convex portion when the first optical element is disposed on the optical path of the beam, a second recessed portion that faces the convex portion when the second optical element is disposed on the optical path of the beam, and a biasing member that biases the convex portion, and may be configured such that, when the optical element disposed on the optical path of the beam is switched from the first optical element to the second optical element, the engagement between the first recessed portion and the convex portion is released against the biasing force of the biasing member, and the second recessed portion and the convex portion are engaged by the biasing force of the biasing member.

According to the above aspect, when the plurality of optical elements are switched, the convex portion engages with the corresponding recessed portion of each optical element, such that the operator can easily grasp that the optical element is disposed at a predetermined position on the optical path.

According to the present disclosure, it is possible to provide an optical sensor capable of reducing a difference in a light intensity between a central portion and a peripheral portion of a spot.

Further, according to the present disclosure, it is possible to provide an optical sensor which is compact and excellent in operability.

### BRIEF DESCRIPTION OF THE DRAWINGS

FIG. 1 is a diagram illustrating an example of an optical sensor according to an embodiment of the present disclosure.

FIG. 2 is a perspective view illustrating an example of a switching mechanism for switching a plurality of distribution change elements.

FIG. 3A illustrates an example of a light intensity distribution of a Gaussian beam.

FIG. 3B is a diagram illustrating an example of a top-hat light intensity distribution of a beam changed from the Gaussian beam.

FIG. 3C is a diagram illustrating an example of a light intensity distribution of a beam changed from the Gaussian beam, where a light intensity of a peripheral portion a spot is greater than in a light intensity of a central portion of the spot.

FIG. 4 is a diagram illustrating an example of a distribution change element using a microlens array.

FIG. 5 is a diagram illustrating a modified example of the microlens array illustrated in FIG. 4.

FIG. 6 is a diagram illustrating an example of a distribution change element using a diffractive optical element.

FIG. 7 is a diagram illustrating an example of a distribution change element using a multi-stage lens.

FIG. 8 is a cross-sectional view illustrating an example of an optical sensor according to a second embodiment of the present disclosure.

FIG. 9 is a perspective view of an example of the spot variable mechanism illustrated in FIG. 8 as viewed obliquely from the front.

FIG. 10 is a perspective view of an example of the spot variable mechanism illustrated in FIG. 8 as viewed obliquely from the rear.

FIG. 11A is a plan view illustrating an example of a pictogram indicating that the shape of the spot is the condensing type and an example of a pictogram indicating that the shape of the spot is the normal type.

FIG. 11B is a plan view illustrating an example of a pictogram indicating that the shape of the spot is the diffusion type and an example of a pictogram indicating that the shape of the spot is the normal type.

### DETAILED DESCRIPTION

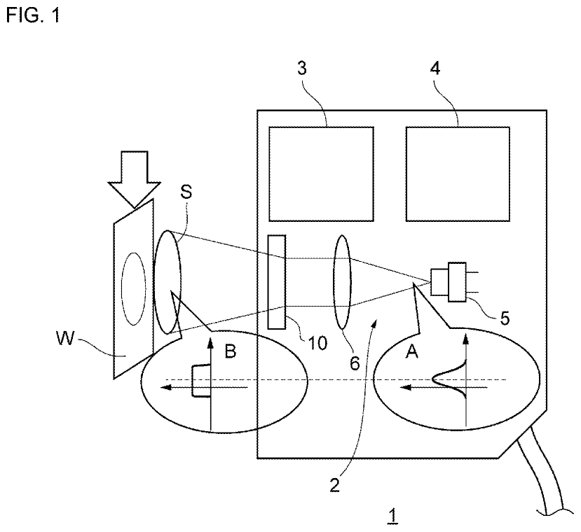

An expedient embodiment of the present disclosure will be described with reference to the attached drawings. In the drawings, components denoted by the same reference numerals have the same or similar configurations. Hereinafter, each configuration will be described in detail with reference to the drawings. In FIGS. 1 to 7, as an example of an optical sensor 1, a time of flight (TOF) sensor that measures a distance based on a time until a beam B projected at a constant period is reflected by a workpiece W and returned is disclosed. The optical sensor 1 is not limited to the illustrated example, and may be a distance-setting type optical sensor other than the TOF type. An example of a distance-setting type optical sensor other than the TOF optical sensor is a triangulation sensor.

As illustrated in FIG. 1, the optical sensor 1 includes a light projecting unit 2, a light receiving unit 3, a circuit board 4, and the like. The light projecting unit 2 includes a light source 5 and projects the beam B to the workpiece W. The light receiving unit 3 includes a light receiving element such as a CMOS image sensor, and receives the beam B reflected and returned from the workpiece W. The circuit board 4 is connected to the light projecting unit 2 and the light receiving unit 3, and calculates the distance between the optical sensor 1 and the workpiece W by measuring the time until the beam B projected from the light projecting unit 2 is reflected by the workpiece W and returned.

The light projecting unit 2 includes at least one distribution change element 10 in addition to the light source 5. As optional components, a collimator 6 disposed between the light source 5 and the distribution change element 10, a switching mechanism 9 that switches the plurality of distribution change elements 10, and the like may be provided. The light source 5 is a laser diode or the like, and emits a beam A having a Gaussian type light intensity distribution. The collimator 6 collimates the Gaussian beam A emitted from the light source 5 and causes the Gaussian beam A to be incident on the distribution change element 10. The distribution change element 10 changes the Gaussian beam A emitted from the light source 5 to the beam B having a light intensity distribution other than the Gaussian type.

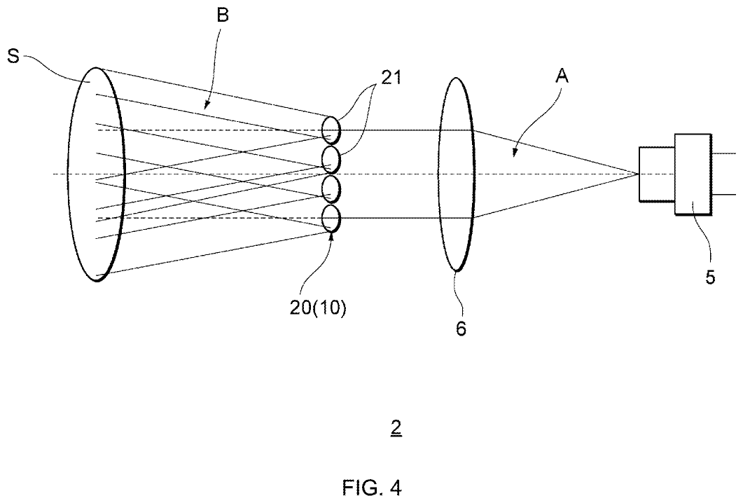

As will be described in detail later with reference to FIGS. 4 to 7, the distribution change element 10 may be an optical element such as a microlens array 20 formed of a plurality of spherical lenses 21 or a plurality of cylindrical lenses 22. It may be an optical element such as the diffraction grating 30. It may be an optical element such as a multi-stage lens. The distribution change element 10 may be rephrased as “an optical element that changes a Gaussian beam A emitted from the light source 5 to the beam B having a light intensity distribution other than a Gaussian type”.

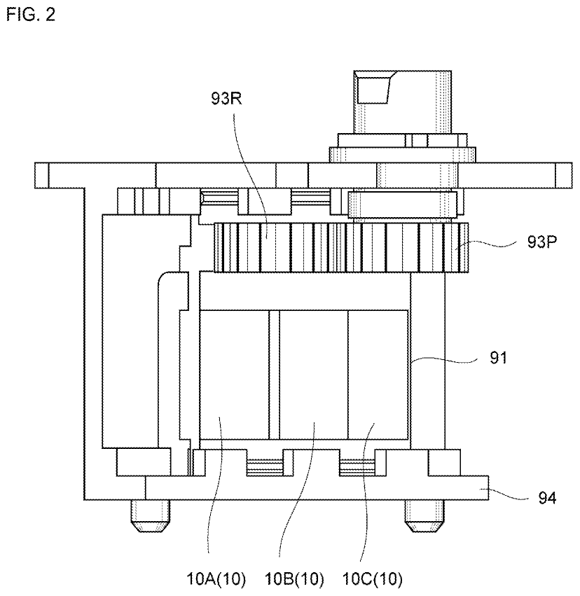

FIG. 2 is a perspective view illustrating an example of the switching mechanism 9 that switches the plurality of distribution change elements 10. The switching mechanism 9 includes, for example, a slider 91 on which a plurality of distribution change elements 10 are arranged in series, a trimmer for operating the slider 91, rack-and-pinion mechanisms 93R and 93P that transmit rotation of the trimmer to the slider 91, and a frame 94 that slidably supports the slider 91. In the example illustrated, first to third distribution change elements 10A to 10C are disposed on the slider 91. The configuration of the switching mechanism 9 is not limited to the illustrated example, and a plurality of distribution change elements may be arranged on a disk that is rotationally driven by a motor.

Each of the first to third distribution change elements 10A to 10C is configured to change the Gaussian beam A emitted from the light sources 5 to the beam B having a light intensity distribution other than a Gaussian type, and is configured to form spots S having different shapes. For example, the shape of the spot S of the beam B can be switched by switching between the first distribution change element 10A and the second distribution change element 10B. The size of the spot S can be enlarged, reduced, or changed according to the workpiece W.

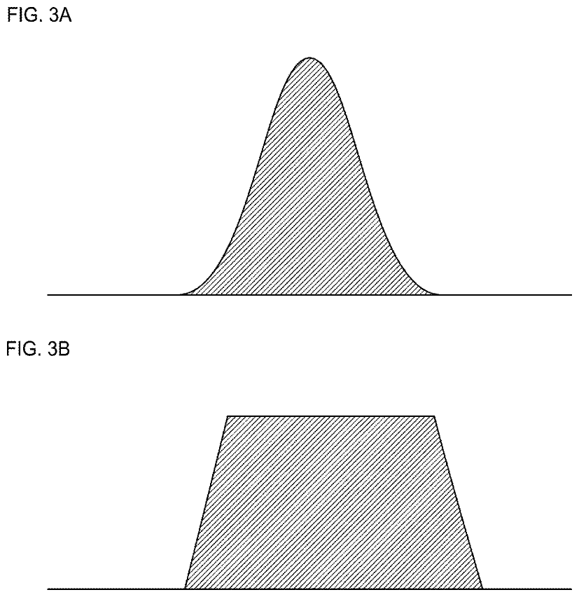

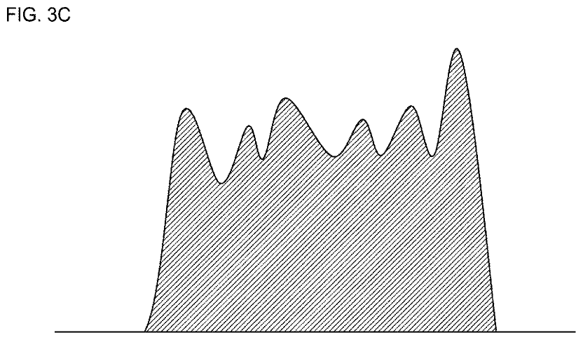

FIG. 3A is a diagram illustrating an example of light intensity distributions of the Gaussian beam A. FIG. 3B is a diagram illustrating an example of a top-hat light intensity distribution of the beam B changed from the Gaussian beam A. FIG. 3C is a diagram illustrating an example of a light intensity distribution of the beam B changed from the Gaussian beam A, where a light intensity of a peripheral portion a spot is greater than in a light intensity of a central portion of the spot.

The light intensity distribution of the Gaussian beam A illustrated in FIG. 3A has a single peak. In contrast, the light intensity distributions other than the Gaussian type light intensity distributions illustrated in FIGS. 3B and 3C have a plurality of peaks. For example, in the top-hat light intensity distribution illustrated in the FIG. 3B, a plurality of peaks having substantially the same intensity are continuous. In the light intensity distributions other than the Gaussian type light intensity distributions illustrated in FIGS. 3B and 3C, the difference in a light intensity between the central portion and the peripheral portion can be reduced as compared with the Gaussian type light intensity distributions in which the central portion of the spot is bright and the peripheral portion is dark.

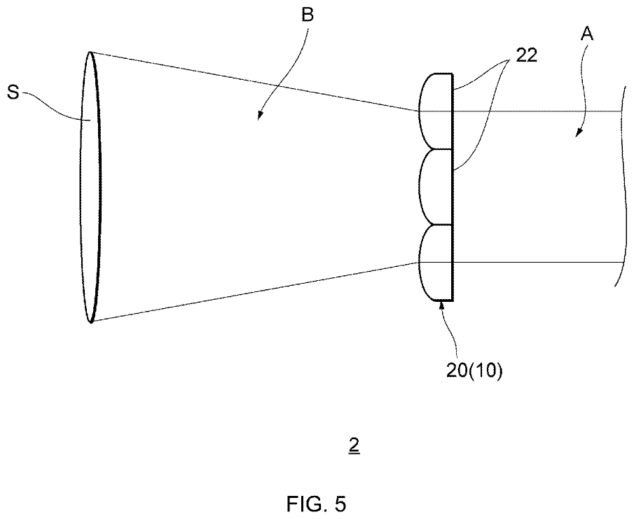

FIG. 4 is a diagram illustrating an example of the distribution change element 10 using the microlens array 20. FIG. 5 is a diagram illustrating a modified example of the microlens array 20 illustrated in FIG. 4. In the example illustrated in FIG. 4, the microlens array 20 is composed of a plurality of spherical lenses 21. As in a modified example illustrated in FIG. 5, the microlens array 20 may include a plurality of cylindrical lenses 22.

The microlens array 20 is configured to change Gaussian beams A, each emitted from the light source 5 and passing through each of the plurality of spherical lenses 21 or each of the plurality of cylindrical lenses 22, into the beam B having a light intensity distribution other than a Gaussian type by overlapping the Gaussian beams A with one other.

When the microlens array 20 is configured by a plurality of spherical lenses 21, as illustrated in FIG. 4, the beam can be changed to an elliptical (substantially circular) beam B having a small difference between a long diameter and a short diameter, which is called a circular beam. When the microlens array 20 is configured by the plurality of cylindrical lenses 22, as illustrated in FIG. 5, the beam can be changed to an elliptical (substantially linear) beam B called a line beam in which a difference between a long diameter and a short diameter is extremely large. The shape of the spot S of the beam B is not particularly limited, and may be rectangular or polygonal.

In the example illustrated in FIG. 4, the collimator 6 is disposed between the light source 5 and the microlens array 20, and the collimated Gaussian beam A is incident on each of the plurality of spherical lenses 21 constituting the microlens array 20. Since it is easy to calculate the intensity of the Gaussian beam A incident on each of the plurality of spherical lenses 21, it is easy to design the microlens array 20 such that the spot S has a desired shape.

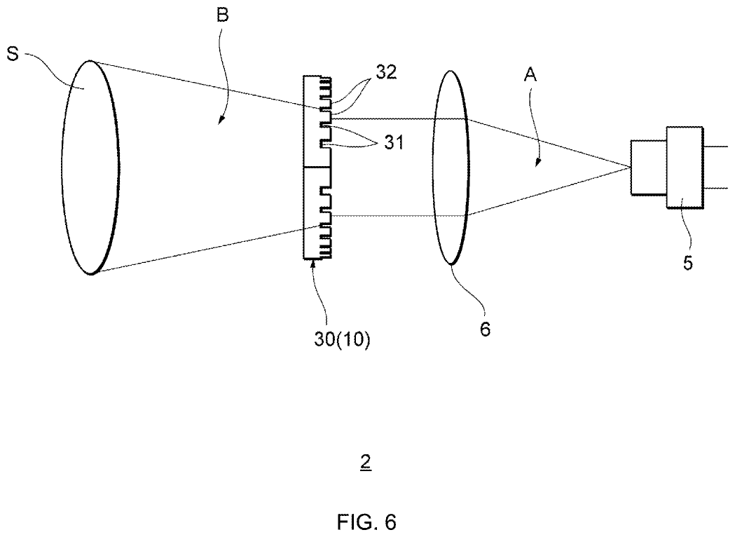

FIG. 6 is a diagram illustrating an example of the distribution change element 10 using the diffractive optical element 30. As illustrated in FIG. 6, a concavo-convex pattern of a fine recessed portion 31 and a fine convex portion 32 for diffusing the Gaussian beam A emitted from the light source 5 is formed on the surface of the diffractive optical element 30. The diffractive optical element 30 is configured to change the Gaussian beam A to the beam B having a light intensity distribution other than a Gaussian type in which a difference in a light intensity between the central portion and the peripheral portion of the spot S is small by diffusing the Gaussian beam A from the central portion to the peripheral portion.

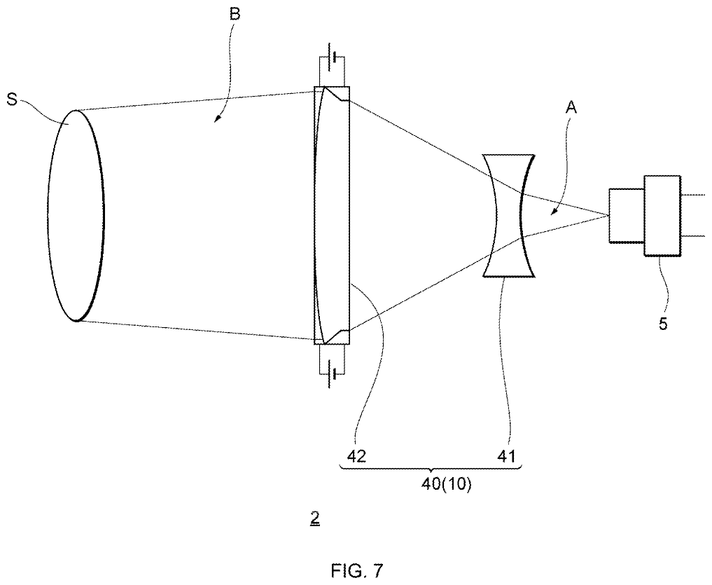

FIG. 7 is a diagram illustrating an example of the distribution change element 10 using the multi-stage lens 40. The multi-stage lens 40 includes at least one concave lens 41 and at least one convex lens 42. The multi-stage lens 40 is configured to diverge the Gaussian beam A emitted from the light source 5 by at least one concave lens 41 and converge the Gaussian beam A by at least one convex lens 42 to change the Gaussian beam A to the beam B having a light intensity distribution other than a Gaussian type. In the example illustrated, the convex lens 42 is formed of a liquid lens.

According to the optical sensor 1 of the present embodiment configured as described above, the size of the spot S can be changed, and the difference in a light intensity between the central portion and the peripheral portion of the spot S can be reduced. Even in the peripheral portion of the spot S, the light intensity required for detecting the workpiece W can be easily obtained, and the presence or absence of the workpiece can be stably detected.

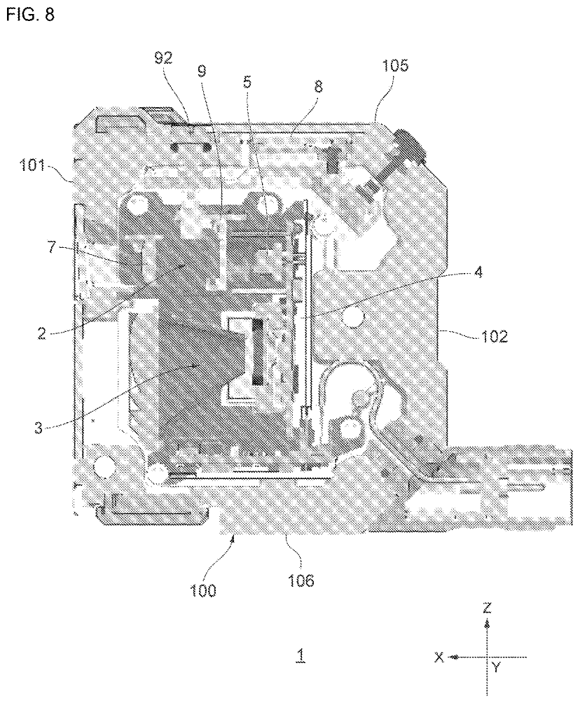

Next, a second embodiment of the present disclosure will be described with reference to FIGS. 8 to 10. The optical sensor 1 of the second embodiment includes a spot variable mechanism 9 configured to be able to switch the shape of the spot S of the beam A by switching the optical elements 50A to 50C disposed on the optical path of the beam A emitted from the light source 5. The number of lenses is not limited to the illustrated example, and may be four or more, or two. In the second embodiment, each of the plurality of optical elements 50A to 50C is not limited to the distribution change element 10 configured to change the Gaussian beam A emitted from the light sources 5 into the beam B having a light intensity distribution other than the Gaussian type, and may be an optical element that transmits the Gaussian beam A emitted from the light sources 5 as it is. In the example illustrated, each of the optical elements 50A to 50C is formed of a flat lens having a different thickness.

FIG. 8 is a cross-sectional view illustrating an example of an optical sensor according to a second embodiment of the present disclosure. As illustrated in FIG. 8, the optical sensor 1 includes a housing 100, and the light projecting unit 2, the light receiving unit 3, the circuit board 4, and the like accommodated in the housing 100. The light projecting unit 2 is constituted of the light source 5, the spot variable mechanism 9, the light projecting lens 7, etc. In the illustrated example, the light projecting unit 2 does not include the collimator 6 illustrated in FIG. 1. The spot variable mechanism 9 has substantially the same configuration as the switching mechanism 9 described in the first embodiment.

The housing 100 is formed in a substantially rectangular parallelepiped shape having a front surface 101, a back surface 102, a top surface 105, a bottom surface 106, a left side surface, and a right side surface. The beams A and B (illustrated in FIG. 1) projected from the light projecting unit 2 are directed from the front surface 101 toward the workpiece W (illustrated in FIG. 1). On the top surface 105, a display 8 capable of displaying information related to setting of the optical sensor 1, a trimmer 92 for operating the spot variable mechanism 9, and the like are disposed.

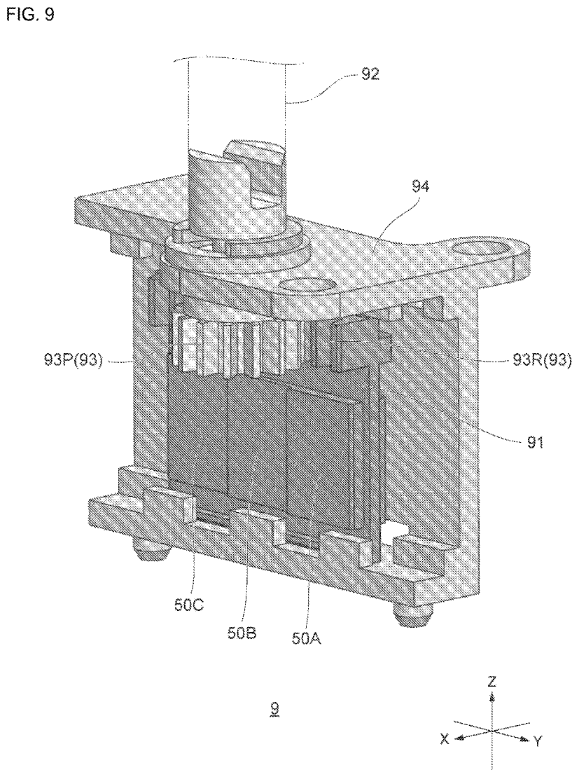

FIG. 9 is a perspective view of an example of the spot variable mechanism 9 illustrated in FIG. 8 as viewed obliquely from the front. As illustrated in FIG. 9, the spot variable mechanism 9 includes a plurality of optical elements 50A to 50C linearly arranged along the first direction Y intersecting the traveling direction X of the beam A, and a linear motion mechanism 93 capable of linearly reciprocating the plurality of optical elements 50A to 50C along the first direction Y. In the example illustrated, the linear motion mechanism 93 is a rack-and-pinion mechanism 93R, 93P, and includes a rack 93R extending linearly along the first direction Y and a pinion 93P meshing with the rack 93R.

The pinion 93P is configured to be operable from the top surface 105 side of the housing 100 facing the second direction Z intersecting both the traveling direction X of light and the first direction Y. The display 8 described above is disposed on the top surface 105. The top surface 105 is an example of a first surface. In the example illustrated, the traveling direction X of light is the front-rear direction, the first direction Y in which the optical elements 50A to 50C are arranged is the left-right direction, and the second direction Z intersecting both the traveling direction X of light and the first direction Y is the up-down direction.

The configuration of the linear motion mechanism 93 is not limited to the rack-and-pinion mechanisms 93R and 93P. For example, a lever provided on the top surface 105 of the housing 100 may be moved in the first direction Y, and the optical elements 50A to 50C driven by the motion of the lever may be reciprocated in the first direction Y. For example, a ball screw may be used. When the nut is a ball screw that reciprocates in the second direction Z, an operation unit such as a trimmer can be provided on the top surface 105 of the housing 100.

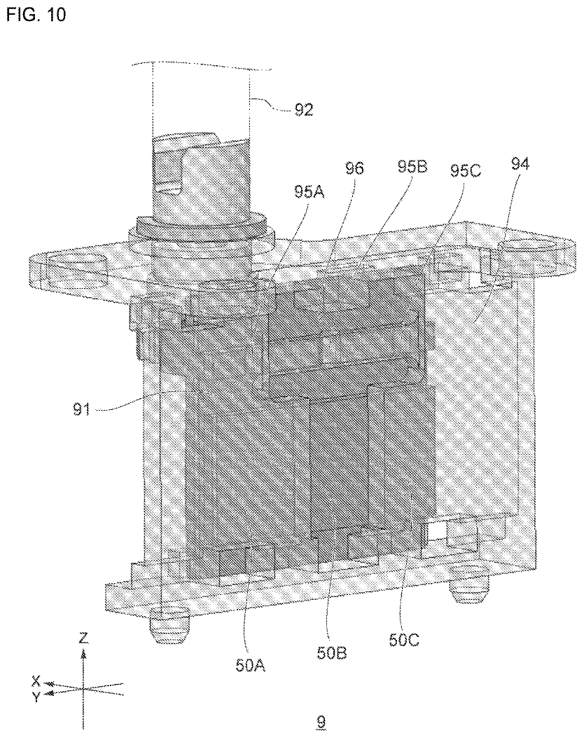

FIG. 10 is a perspective view of an example of the spot variable mechanism 9 illustrated in FIG. 8 as viewed obliquely from the rear. As illustrated in FIG. 10, the slider 91 is provided with recessed portions 50A to 50C corresponding to the plurality of optical elements 95A to 95C, respectively. The frame 94 is provided with a convex portion 96. When the optical element 50A is disposed on the optical path of the beam A, the recessed portion 95A faces the convex portion 96. Similarly, when the optical element 50B is disposed on the optical path of the beam A, the recessed portion 95B faces the convex portion 96, and when the optical element 50C is disposed on the optical path of the beam A, the recessed portion 95C faces the convex portion 96.

The optical element 50A is an example of a first optical element, and the recessed portion 95A is an example of a first recessed portion. Similarly, the optical element 50B is an example of a second optical element, and the recessed portion 95B is an example of a second recessed portion. The slider 91 and/or the frame 94 are formed of a resin material and have flexibility. When the optical elements 50A to 50C disposed on the optical path of the beam A are switched, the slider 91 and/or the frame 94 are deformed, and any one of the recessed portions 95A to 95C facing the convex portion 96 and the convex portion 96 are engaged with each other by a biasing force by which the deformed slider 91 and/or frame 94 are to be restored.

For example, when the optical element disposed on the optical path of the beam A is switched from the optical element 50A to the optical element 50B, if the slider 91 is moved leftward in the first direction Y, the slider 91 and/or the frame 94 is deformed, and the engagement between the recessed portion 95A and the convex portion 96 is released against the biasing force by which the deformed slider 91 and/or frame 94 is restored. When the slider 91 is further moved leftward, the recessed portion 95B faces the convex portion 96, and the recessed portion 95B and the convex portion 96 are engaged with each other by the biasing force by which the deformed slider 91 and/or the frame 94 are to be restored. The slider 91 and/or the frame 94 is an example of a biasing member that biases the convex portion 96 toward the recessed portion facing the convex portion 96 (the recessed portion 95B in the example illustrated).

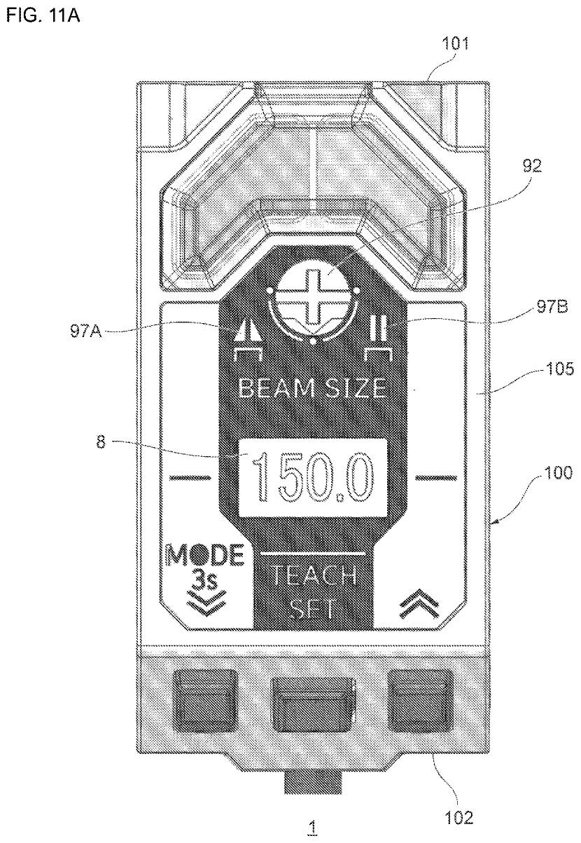

Assuming that the shape of the spot S in the state in which the optical element 50B is disposed on the optical path of the beam A is the normal type, when the optical element disposed on the optical path of the beam A is switched from the optical element 50B to the optical element 50B having a larger plate thickness than the optical element 50A, the beam A can be condensed to reduce the size of the spot S. FIG. 11A is a plan view illustrating an example of the pictogram 97A indicating that the shape of the spot S is the condensing type and an example of the pictogram 97B indicating that the shape of the spot S is the normal type. When the optical element disposed on the optical path of the beam A is switched from the optical element 50B to the optical element 50B having a smaller plate thickness than the optical element 50C, the beam A can be diffused to enlarge the size of the spot S. FIG. 11B is a plan view illustrating an example of the pictogram 97C indicating that the shape of the spot S is the diffusion type and an example of the pictogram 97B indicating that the shape of the spot S is the normal type. In the example illustrated in FIG. 11A, the current position of the trimmer 92 is indicated by a mountain-shaped mark, the selectable positions of the trimmer 92 are indicated by dot marks, and the movement path of the trimmer 92 is indicated by an arc-shaped mark. It is easy for the operator to intuitively grasp that the shape of the spot S becomes the condensing type when the trimmer 92 is rotated clockwise, and the shape of the spot S becomes the normal type when the trimmer 92 is rotated counterclockwise. In the illustrated example, when the position of the trimmer 92 is at an intermediate position among the three possible positions, the type of spot S is not clearly indicated by the pictogram, but is different from the condensing type and the normal type, and is a slightly condensing type corresponding to an intermediate state between the condensing type and the normal type. The marks of the current position, the selectable positions, and the moving path of the trimmer 92 are not limited to the illustrated example. Further, the example illustrated in FIG. 11B is the same as the example illustrated in FIG. 11A. Therefore, redundant description will be omitted.

According to the optical sensor 1 of the second embodiment configured as described above, since the plurality of optical elements 50A to 50C are linearly moved by the linear motion mechanism 93 instead of rotating the plurality of optical elements by the rotation mechanism, the optical axis of the beam A and the rotation axis of the trimmer 92 are not parallel to each other. The trimmer 92 disposed on the top surface 105 can be operated while the optical axis is visually confirmed. Moreover, the size of the optical sensor 1 can be easily reduced as compared with the related art in which the light projecting lens is displaced or the rotating disk is rotated. Therefore, it is possible to provide the optical sensor 1 which is compact and excellent in operability.

The above-described embodiment is provided for facilitating understanding of the present disclosure, and is not intended to limit the interpretation of the present disclosure. Each element included in the embodiment as well as the arrangement, material, condition, shape, size, and the like of each element are not limited to those exemplified and may be changed appropriately. Further, the configurations described in different embodiments can be partially replaced or combined.

### Supplementary Note 1

An optical sensor (1) including a light source (5) configured to emit a Gaussian beam (A) and at least one distribution change element (10), wherein each of the at least one distribution change element (10) is configured to change the Gaussian beam (A) emitted from the light source (5) to a beam (B) having a light intensity distribution other than a Gaussian type.

### Supplementary Note 2

An optical sensor (1) including: a light source; and a spot variable mechanism (9) configured to be capable of switching a shape of a spot of the beam (A) by switching optical elements (50A to 50C) disposed on an optical path of the beam (A) emitted from the beam source (5), wherein the spot variable mechanism (9) includes: a plurality of optical elements (50A to 50C) linearly arranged along a first direction (Y) intersecting a traveling direction (X) of the beam (A); and a linear motion mechanism (93) capable of linearly reciprocating the plurality of optical elements (50A to 50C) along the first direction (Y).

### REFERENCE SIGNS LIST

1 Optical sensor
2 Light projecting unit
3 Light receiving unit
4 Circuit board
5 Beam source
6 Collimator
7 Light projecting lens
8 Display
9 Switching mechanism (Spot variable mechanism)
10 Distribution change element
10A to 10C First to third distribution change elements
20 Microlens array
21 Spherical lens
22 Cylindrical lens
30 Diffractive optical element
31 Recessed portion
32 Convex portion
40 Multi-stage lens
41 Concave lens
42 Convex lens
50A to 50C Optical elements,
91 Slider (an example of biasing member)
92 Trimmer
93 ‘Linear motion mechanism
93P Pinion
93R Rack
94 Frame (an example of biasing member)
95A to 95C Optical elements
96 Convex portion
97A to 97C Pictograms
100 Housing
101 Front surface
102 Back surface
105 Top surface
106 Bottom surface
A Beam of Gaussian type (Gaussian beam)
B Beam other than Gaussian type
S Spot
W Workpiece
X Traveling direction
Y First direction
Z Second direction

The various embodiments described above can be combined to provide further embodiments. All of the patents, applications, and publications referred to in this specification and/or listed in the Application Data Sheet are incorporated herein by reference, in their entirety. Aspects of the embodiments can be modified, if necessary to employ concepts of the various patents, applications, and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

1-10. (canceled)

11. An optical sensor including:
a light source; and
a spot variable mechanism configured to be capable of switching a shape of a spot of a beam by switching optical elements disposed on an optical path of the beam emitted from the beam source, wherein
the spot variable mechanism includes
a plurality of optical elements linearly arranged along a first direction intersecting a traveling direction of the beam, and
a linear motion mechanism capable of linearly reciprocating the plurality of optical elements along the first direction.

12. The optical sensor according to claim 11, wherein
the linear motion mechanism is a rack-and-pinion mechanism, and
the linear motion mechanism includes a rack extending linearly along the first direction and a pinion meshing with the rack.

13. The optical sensor according to claim 12, further comprising:
a housing configured to house the light source, wherein
the pinion is configured to be operable from a first surface of the housing facing a second direction intersecting both the traveling direction and the first direction.

14. The optical sensor according to claim 12, further comprising:
a housing configured to house the light source; and
a display capable of displaying information related to setting of the optical sensor, wherein
the pinion is configured to be operable from a first surface of the housing on which the display is disposed.

15. The optical sensor according to claim 11, wherein
the plurality of optical elements include a first optical element and a second optical element,
the spot variable mechanism further includes
a convex portion,
a first recessed portion facing the convex portion when the first optical element is disposed on the optical path of the beam,
a second recessed portion facing the convex portion when the second optical element is disposed on the optical path of the beam, and
a biasing member configured to bias the convex portion, and
the optical sensor is configured such that, when the optical element disposed on the optical path of the beam is switched from the first optical element to the second optical element, engagement between the first recessed portion and the convex portion is released against a biasing force of the biasing member, and the second recessed portion and the convex portion are engaged by the biasing force of the biasing member.
